(19) United States
(12) Patent Application Publication
(10) Pub. No.: US 2021/0028924 A1
(43) Pub. Date: Jan. 28, 2021

(54) SYSTEM AND METHOD FOR EXTENDABLE CRYPTOGRAPHY IN A DISTRIBUTED LEDGER

(71) Applicant: Insolar Technologies GmbH, Zug (CH)

(72) Inventors: Kirill Ivkushkin, Moscow (RU); Vladimir Stepanov, Moscow (RU); Pavel Kirillov, Moscow (RU); Andrei Zhulin, Moscow (RU); Petr Fedchenkov, Moscow (RU); Dmitrii Zhulin, Moscow (RU)

(21) Appl. No.: 16/937,904

(22) Filed: Jul. 24, 2020

Related U.S. Application Data
(60) Provisional application No. 62/878,833, filed on Jul. 26, 2019.

(51) Int. Cl. H04L 9/06; G06F 21/64

(52) U.S. Cl. CPC H04L 9/0643; H04L 2209/38; G06F 21/64

(57) ABSTRACT

Disclosed herein are systems and method for extendable cryptography in a distributed ledger. In an exemplary aspect, a method receives a request to process an object by generating a new record data of the object and adding, to a distributed ledger, a new record comprising the new record data associated with the object. The method obtains hash information for a preceding record in the distributed ledger. The method generates a new platform hash and a new custom hash for the new record, and creates a main portion of the new record, the main portion comprising the new record data, the platform hash of the previous record, and the new platform hash. The method generates and appends an extendable portion to the new record, the extendable portion comprising the custom hash of the previous record and the new custom hash. The method then adds the new record to the distributed ledger.

### CROSS-REFERENCE TO RELATED APPLICATIONS

This application claims the benefit of U.S. Provisional Application No. 62/878,833, filed Jul. 26, 2019, which is herein incorporated by reference.

### FIELD OF TECHNOLOGY

The present disclosure relates generally to the field of blockchain technology, more specifically, to systems and methods for extendable cryptography in a distributed ledger.

### BACKGROUND

Existing blockchain platforms (e.g., Ethereum) provide only predefined cryptographic schemes and do not offer the ability to implement user-defined custom cryptography at the platform level. To implement additional cryptography, application developers have to provide business logic at the application level (that is, outside of the blockchain platform). Existing blockchains and DLT platforms are unable to support several cryptography schemes natively (inside a distributed ledger). Various cryptography schemes could be implemented on a business logic level if additional data is saved in the records, but this is time consuming, expensive in terms of computation, and prone to errors. This results in a lack of conformity to organizational standards, as well as lack of interoperability in cross-organizational agreement management and business communications.

### SUMMARY

Aspects of the disclosure relate to the field of blockchain technology. In particular, aspects of the disclosure describe methods and systems for extendable cryptography in a distributed ledger.

In one exemplary aspect, a method comprises receiving a request to process an object by generating a new state for the object and adding a new record comprising new record data (i.e., a set of record data fields) of the object to a distributed ledger. In the present disclosure, a record is a data structure that comprises a main portion and an extendable portion. The main portion of a record may comprise at least a record identifier (or reference), record data, and a hash of the previous record (e.g., in a chain of the object's states) calculated according to the platform cryptography rules. The extendable portion may comprise of one or several sections for custom cryptography. In response to the request, the method comprises obtaining hash information for a preceding record in the distributed ledger, wherein the hash information further comprises a platform hash associated with a platform of the distributed ledger and one or more custom hashes (each custom hash associated with a custom cryptographic scheme for a security requirement).

Subsequently, the method creates a main portion of the new record. The method creates a record identifier of the new record, obtains a platform hash of the previous record in the object's lifeline, calculates the cryptographic signature of the new record data (in accordance with the platform cryptographic scheme). The record data, the platform hash of the previous record, and the cryptographic signature are included in the main portion of the new record.

The method further creates an extendable portion of the new record. The method obtains a custom hash of the previous record and calculates another cryptographic signature of the new record data using a selected custom cryptographic scheme. The custom hash of the previous record and the another cryptographic signature are included in the extendable portion of the new record.

The method further comprises combining the main portion and the extendable portion of the new record and adding the new record to the distributed ledger.

In some aspects, the main portion further comprises a record identifier of the new record.

In some aspects, the new record data comprises information about a transaction between a first counterparty and a second counterparty, wherein the first counterparty provides the custom cryptographic scheme to the platform and the second counterparty provides a different custom cryptographic scheme to the platform, and wherein processing of both the custom cryptographic scheme and the different custom cryptographic scheme are supported natively by the platform and not implemented on a business logic level (business logic being the logic implemented in the processed smart contract). The method further comprises generating another custom hash via the different custom cryptographic scheme, and including the another custom hash in the extendable portion.

In some aspects, the custom cryptographic scheme comprises an algorithm for applying a cryptographic transformation and identifies compatible data formats for the cryptographic transformation, wherein being provided the custom cryptographic scheme comprises receiving executable code of the custom cryptographic scheme for storage in a payload of a record associated with an object dedicated for storing cryptographic schemes, prior to receiving the request to add the new record. The method further comprises storing the executable code in the payload, and invoking the executable code to generate the custom hash.

In some aspects, custom hashes of a plurality of records in the distributed ledger pertaining to the lifeline of a specific object are comprised in an integrity directory, wherein the integrity directory is logically composed from dedicated subsections of each record in the distributed ledger and comprises the extendable portion of the new record. In some aspects, each record may comprise a plurality of integrity directories, wherein each integrity directory is associated with one or more cryptography schemes. In some aspects, each respective integrity directory comprises a unique cryptography scheme.

In some aspects, the integrity directory further comprises custom signatures.

In some aspects, the integrity directory is a cross-record sequence for the distributed ledger.

In some aspects, the integrity directory further comprises auxiliary information identifying physical nodes involved in transaction processing within the platform of the distributed ledger.

It should be noted that the methods described above may be implemented in a system comprising a hardware processor. Alternatively, the methods may be implemented using computer executable instructions stored on a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of a system for managing and storing a distributed ledger of records, according to an exemplary aspect.

FIG. 2 is a block diagram illustrating an extendable record in the blockchain according to an exemplary aspect.

FIG. 3 is a block diagram depicting an integrity directory according to exemplary aspects of the present disclosure.

FIG. 4 is a flow diagram for creating an extendable distributed ledger, according to an exemplary aspect.

FIG. 5 is a flow diagram for invoking custom cryptographic schemes, according to an exemplary aspect.

FIG. 6 is a block diagram illustrating an example architecture for a blockchain network.

FIG. 7 is a block diagram of a computer system on which the disclosed system and method can be implemented according to an exemplary aspect.

### DETAILED DESCRIPTION

Exemplary aspects are described herein in the context of a system, method, and computer program product for extendable cryptography in a distributed ledger. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

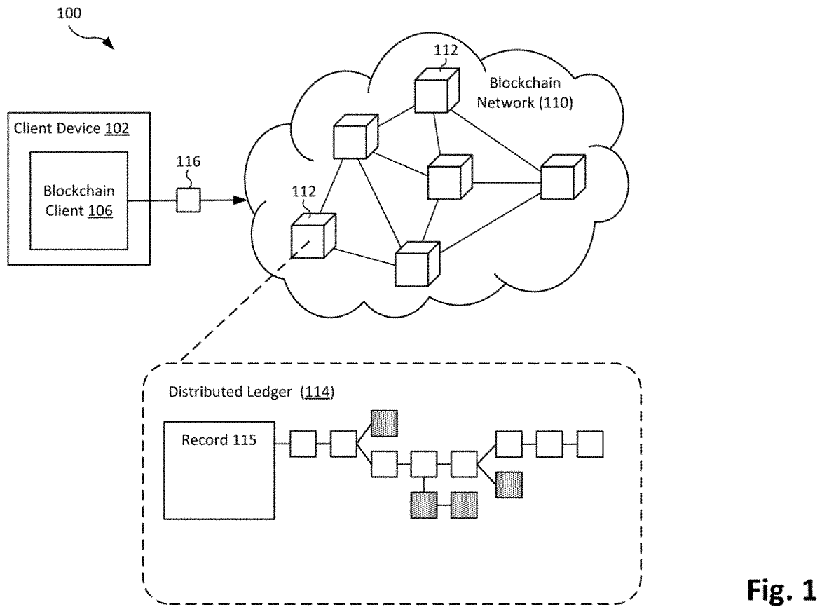

FIG. 1 is a block diagram of a system 100 for managing and storing a distributed ledger of records, according to an exemplary aspect. The system 100 may include one or more client device(s) 102 communicatively connected to a blockchain network 110. The client device 102 may be one of personal computers, servers, laptops, tablets, mobile devices, smart phones, cellular devices, portable gaming devices, media players or any other suitable devices that can retain, manipulate and transfer data. The client device 102 may include a blockchain client 106, which is a software application configured to generate and transmit one or more blockchain-based transactions or messages 116 to the blockchain network 110 for accessing or modifying records stored in the distributed ledger, such as managing user accounts, the transfer of cryptographic assets to and from such user accounts, and other types of operations.

According to an exemplary aspect, the blockchain network 110 can be a distributed peer-to-peer network formed from a plurality of nodes 112 (computing devices) that collectively maintain a distributed ledger 114, which may contain one or more blockchains 114. For purposes of the present discussion, the terms distributed ledger and blockchain may be interchangeably used. The blockchain 114 is a continuously-growing list of data records hardened against tampering and revision using cryptography and is composed of data structure blocks that hold the data received from other nodes 112 or other client nodes, including the client device 102 executing an instance of the blockchain client 106. The blockchain client 106 is configured to transmit data values to the blockchain network 110 as a transaction data structure 116, and the nodes 112 in the blockchain network records and validates/confirms when and in what sequence the data transactions enter and are logged in the existing blockchain 114.

The distributed ledger may be organized into multiple blockchains 114 which are configured to ensure chronological and immutable storage of data. In one aspect, the distributed ledger may include one or more lifeline blockchains, sideline blockchains, and jet blockchains. In one implementation, lifeline blockchains are individual blockchains in which each data object and all its states are stored (i.e., objects are treated as individual blockchains). Lifeline blockchains can have logic and code associated with them, so the terms lifeline blockchain, object, and smart contract may be used interchangeably. In one aspect, sideline blockchains are utility lifeline blockchains used to store temporary or auxiliary data such as indexes, pending operations, or debug logs. A lifeline blockchain can have several associated sideline blockchains to store information. A jet blockchain may be configured to act as a shard or partition which make up storage blocks and form shard chains. Records in a jet blockchain may be first produced by a lifeline blockchain, then packaged into blocks, and placed in sequence to form a chain of blocks. Replication and distribution of data can be managed individually by blocks and jet blockchains. The use of multiple kinds of blockchains enables dynamic reconfiguration of storage by splitting and merging of jet blocks without comprising data immutability.

Distributed ledgers, e.g., having a blockchain 114, are used to store a plurality of records 115, which may contain information such as a request, a response, a control of state, and maintenance details. In known approaches to blockchain technology, records 115 of a distributed ledger are ordered chronologically by time of creation or registration, and each record of a ledger may represent an operation (or a change) made and can have a reference to a previous record which represents a baseline for the operation. The reference uniquely identifies an entity (e.g., record) and is based on or includes information (e.g., checksum, hash, or signature) to validate the integrity of the entity the reference points to.

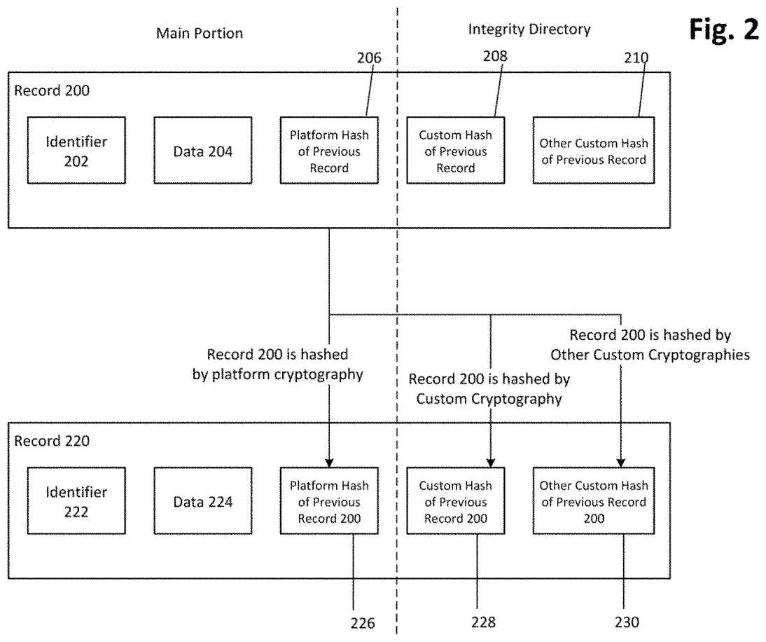

According to an aspect, the blockchain 114 is configured such that a record 115 contained in the blockchain contains a reference to a previous record and hash information. In some aspects, as shown in FIG. 2, each record in the blockchain 114 comprises a main portion and an extendable portion. The main portion of each record, for example record 200, comprises an identifier 202 and data 204 and a platform hash 206 of a previous record. The platform hash 206 is a reference to the previous record in the blockchain. As new records are added to the blockchain 114, each record contains the platform hash for the preceding record to create the chronological chain of records in the blockchain 114. In exemplary aspects, each record in blockchain 114, for example record 200, also contains an extendable portion. The extendable portion allows for one or more cryptography schemes to store artifacts in the record, wherein the cryptography schemes are added to the platform through a pluggable mechanism. In exemplary aspects, the pluggable mechanism may include a smart contract that manages different cryptography schemes. The smart contract may allow uploading of a cryptography library, definition of a key storage, and specifying interfaces to be called from other smart contracts and from the platform itself to, for example, invoke cryptographic functions and create entries in an integrity directory, discussed further below. The extendable portion of the record 200 contains one or more custom hashes 208 and 210 of a preceding record. These custom hashes also serve as references to the preceding record. Similarly, record 220 contains an identifier 222, data 224 and a platform hash 226 of the previous record 200 in the main portion. The record 220 also contains an extendable portion with one or more custom hashes 228 and 230 of previous record 200. According to some aspects, the extendable portion of the record is implemented as data nested within the data structure of the record, though other implementations are also contemplated. The record 200 is hashed by a cryptographic method chosen at the platform level for the blockchain 114. Thus record 220 contains the hash 226 generated by platform cryptography method that references record 200. Additionally, the record 220 contains one or more custom hashes that reference the previous record, in this case, record 200. Since the records contain this extendable portion, the platform of the blockchain 114 can provide the possibility to implement user-defined cryptography, instead of this additional cryptography being provided at the application level, outside of the blockchain platform. Furthermore, since the extendable portion of each record in the blockchain 114 can contain one or more custom hashes, a single platform in the system 100 supports multiple cryptography schemes natively inside a distributed ledger. This also avoids the need by clients to add business logic level cryptography schemes which may be time and resource consuming, and prone to errors. Accordingly, in blockchain 114, data object history (e.g., the sequence of events) is maintained via the standard platform cryptography (e.g., platform hash 206 and platform hash 226), while additional cryptography schemes are realized by their own hashing mechanisms using a record linking and addressing system, for example an integrity directory.

Thus the system 100 allows for blockchain platforms to be implemented at the enterprise level adhering to various cryptography standards or schemes enforced by regulatory bodies or by company policy seamlessly. Furthermore, cross-border contracting between companies often requires adherence to several national cryptographic standards or schemes simultaneously. The extendable portion of each record in the blockchain 114 allows for such adherence while minimizing the excessive cost in terms of data protection that comes with the current methods. Further, when two or more different organizations interact, multiple different cryptographic schemes may be used. In aspects of the system 100, data sets can be saved in accordance with several of these cryptographic methods, without having to implement additional logic outside of the platform for encryption and integrity verification.

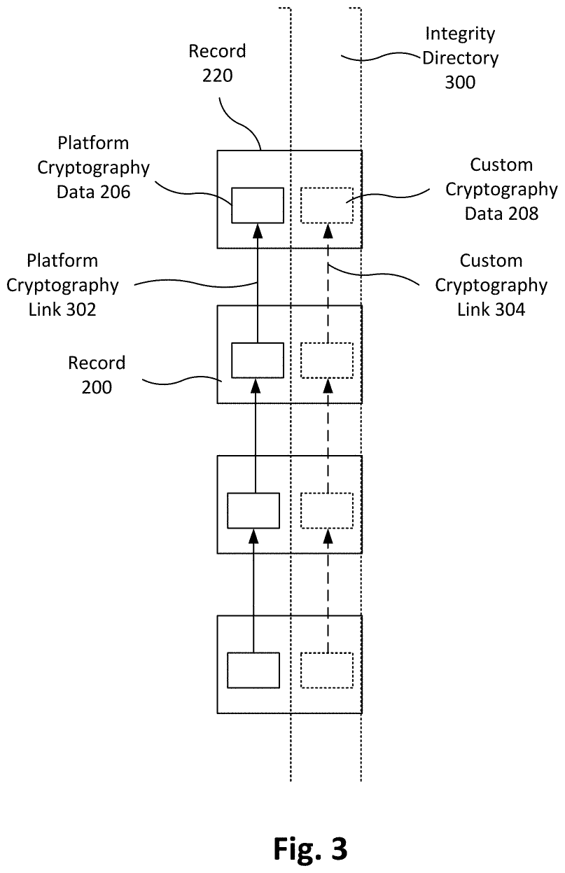

FIG. 3 illustrates a blockchain structure including an integrity directory 300, according to exemplary aspects of the present disclosure. In this aspect, the integrity directory 300 is a logical structure containing hashes and signatures made in accordance with the plugged cryptographic schemes. The integrity directory 300 links related records (e.g., 200 and 220) by storing the previous record's hash made by the custom cryptography. The integrity directory 300 appends additional links (the one or more custom cryptographic hashes) to the previous record, in addition to the linking provided by the built-in, predefined platform cryptography scheme. The integrity directory includes the cryptographic hashes, but can also contain applicable cryptographic signatures.

In exemplary aspect, each record (e.g., record 220) in the blockchain 114 contains a platform cryptography link 302 referencing a previous record (e.g., record 200) and one or more custom cryptography links 304 that reference custom cryptography data 208 from the previous record. The custom cryptography link 304 and the associated data 208 form the integrity directory 300. The integrity directory 300 is a logical structure containing hashes and signatures made in accordance with the plugged cryptographic schemes, thus allowing related records to be linked by storing the previous record's hash made by the custom cryptography. The integrity directory 300 adds additional links to the previous record, in addition to the linking provided by the built-in, predefined platform cryptography scheme. The integrity directory 300 includes the cryptographic hashes, but may also include applicable cryptographic signatures. In exemplary aspects, the blockchain platform will handle insertion and retrieval of records in the integrity directory 300.

In exemplary aspects, each record (e.g., record 200) may have one or more different custom hashes and subsequent records (e.g., record 220) can reference these records using a link (e.g., link 304) to the custom hash (e.g., data 208). Linking means that each subsequent record comprises a hash of the previous record, made according to a particular cryptography scheme. In particular, custom cryptography hash 208 in the record 220 may contain a hash of record 200 made according to the custom cryptography scheme. The same is true for platform cryptography (206 instead of 208, everything else the same). The data that is used when calculating a hash may be different for different schemes (i.e., the custom scheme may only take into account the main portion plus the relevant custom integrity directory portion, whereas platform integrity directory always takes only the main portion). For the identification of the record as a whole, and for lookups of the record within the platform, there is the record identifier (i.e., identifier 222 or identifier 202 in FIG. 2). Accordingly, a record may be identified using the platform hash (e.g., data 206) or any one of the custom hashes (e.g., data 208) in the integrity directory 300. The data object history (sequence of events) is maintained via standard cryptography (here: platform cryptography), while any additional cryptography scheme is realized by its own hashing mechanism using an addressing system—the integrity directory 300. The data across the records is linked chronologically and cryptographically, with several references between the data: one for linking of the previous record to the next (via platform cryptography), and another for linking the same or different records via cryptographic hashes of custom scheme(s).

In some aspects, the integrity directory 300 forms a cross-record sequence of cryptographic hashes, where there may be several different cryptography schemes at play. In some aspects, the integrity directory 300 is associated with a single cryptography scheme and there may be a plurality of integrity directories, each associated with one or many different cryptography schemes, for a given blockchain. A cryptographic scheme is a specification of a sequence of cryptographic transformations and the data formats used for cryptographic transformations. An example of a cryptographic scheme is a scheme with public and private keys (RSA). In some aspects, cryptographic schemes may be loaded into the platform, and made available for use as plugins. Algorithms of cryptographic transformations may be saved into the distributed ledger in the form of source or executable code (like a smart contract). Adding new custom code for execution by the platform may involve invoking special API for uploading new code. The code may be stored by the platform as a payload (e.g., data) in the record of a special type (e.g., ‘custom smart contract class code’, or ‘cryptography scheme code’). The records of special types form their own blockchain similar to the way the object states or smart contract code are stored. Code acts as the payload for the records, and records with different states of the code are chained into the blockchain. In particular, the platform connects the new records to the blockchain. Platform mechanisms facilitate invocation of the stored code according to operation type, e.g., invocation of a custom smart contract or a particular class, or invocation of certain cryptography scheme of a particular type. The stored code can be called like a smart contract, which in turn can call other smart contracts as routines. The platform provides means of invocation of the custom cryptography scheme whenever necessary. As a result, there may be some hashes and signatures produced and added to the custom integrity directory of an object that is being processed.

Cryptographic transformations may also be performed outside of the distributed ledger (e.g., whenever the computation involves a secret that a particular party is not willing to share under certain circumstances). The code of transformations can be provided externally and the resulting artefacts (e.g., signatures) may be saved in the DLT. Cryptographic transformations produce results such as hashes and cryptography signatures. These hashes and cryptography signatures are stored by the platform in the integrity directories. From the storage perspective, the integrity directory 300 is composed of a dedicated subsections of a record for storing custom hashes and signatures created according to a certain cryptography scheme. A record may contain several such subsections for different cryptography schemes, facilitating several integrity directories. Each integrity directory 300 and the associated cryptography scheme can be used to satisfy particular regulatory requirements or corporate data protection standards.

Cryptographic schemes are implemented as executable code, which is stored in objects/lifelines (and records) of a special type. Smart contract types (or classes) are stored in the same way, i.e., in objects of a special type. Storage of code (e.g., of smart contract types or cryptography schemes or any other potentially executable entities) is decoupled from any particular individual objects which are instances, i.e., which are storing states.

All objects are referenced by the platform, i.e., they have an address associated with them. Whenever the platform handles the call to, for example, a smart contract of a particular type or to a cryptography scheme, the platform must be provided with the address, type, and particular method to be invoked. With those parameters, the platform verifies that the type is indeed correct (i.e., what is expected on the caller side corresponds to the actual object type), the required method exists and can be called according to the parameters specified in the call and to security settings. Then the platform retrieves the executable code or pre-compiles the source code (if the type is stored in the form of a source code), instantiates an environment for execution, uploads the code to it, and initiates handling of the call.

Custom cryptographic schemes are different from smart contract types or from a platform cryptographic scheme in that upon their deployment they must become known to all members of the network, i.e. nodes, so that the platform will be able to build and verify the blockchain using this new custom type of cryptography. In particular, that means that the nodes must generate all relevant secrets to sign the transactions or records, and do so in a way which is allowed by the network.

An exemplary algorithm of forming a chain of connected records in extendable cryptography ledger includes receiving input data to store in a new record and linking this new record to a previous record. In exemplary aspects, the platform hash is placed into the platform integrity directory (part of the new record), while the custom hash is placed into the custom integrity directory 300 as part of the new record. The integrity directory 300 allows the system 100 to provide integrity not only over the main portion of the record but also over auxiliary/technical information like details as to which physical node has been involved in the transaction processing within the platform. Furthermore, the integrity directory 300 serves to allow several cryptography-dependent chains inside a single ledger of records in exemplary aspects.

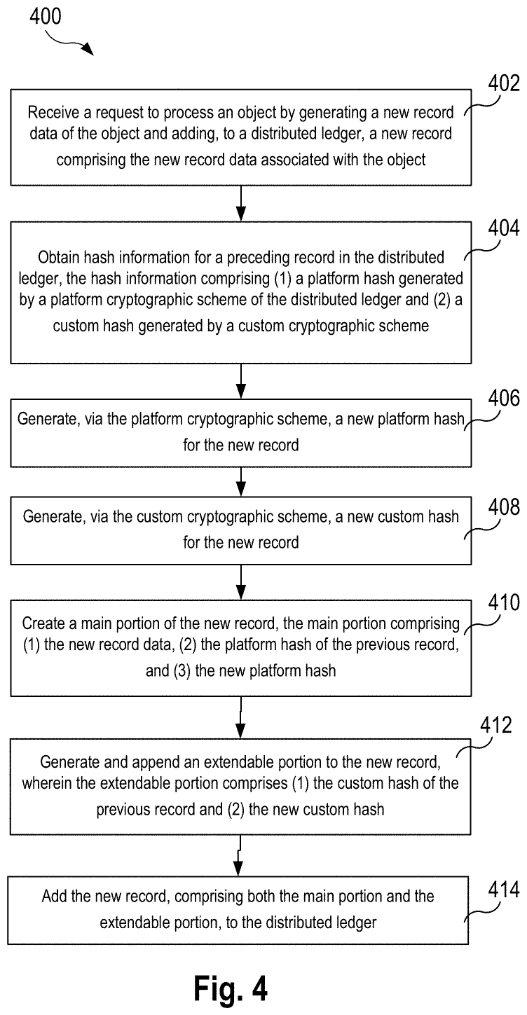

FIG. 4 is a flow diagram for extendable cryptography in a distributed ledger, according to an exemplary aspect.

The method begins at 402, where a request is received at a blockchain platform to process an object by generating a new record data (including a new state) of the object and adding, to a distributed ledger, a new record comprising the new record data associated with the object.

In order to add the new record, hash information is obtained regarding a preceding record in the blockchain at 404. The hash information includes (1) a platform hash generated by a platform cryptographic scheme of the distributed ledger and (2) a custom hash generated by a custom cryptographic scheme. In exemplary aspects, the custom cryptographic scheme is implemented in order to comply with various security requirements of companies, organizations, servers, countries or the like.

At 406, a new platform hash for the new record is generated via a platform cryptographic scheme. At 408, a new custom hash for the new record is generated via the custom cryptographic scheme.

At 410, a main portion of the new record is created, the main portion comprising (1) the new record data, (2) the platform hash of the previous record, and (3) the new platform hash.

The method 400 then proceeds to 412, where an extendable portion is generated and appended to the new record, wherein the extendable portion comprises (1) the custom hash of the previous record and (2) the new custom hash.

At 414, the new record comprising both the main portion and the extendable portion is added to the distributed ledger. Accordingly, each new record will contain references to previous records via the platform hash along with a reference to the custom hash, allowing the blockchain to dynamically adapt to various security requirements.

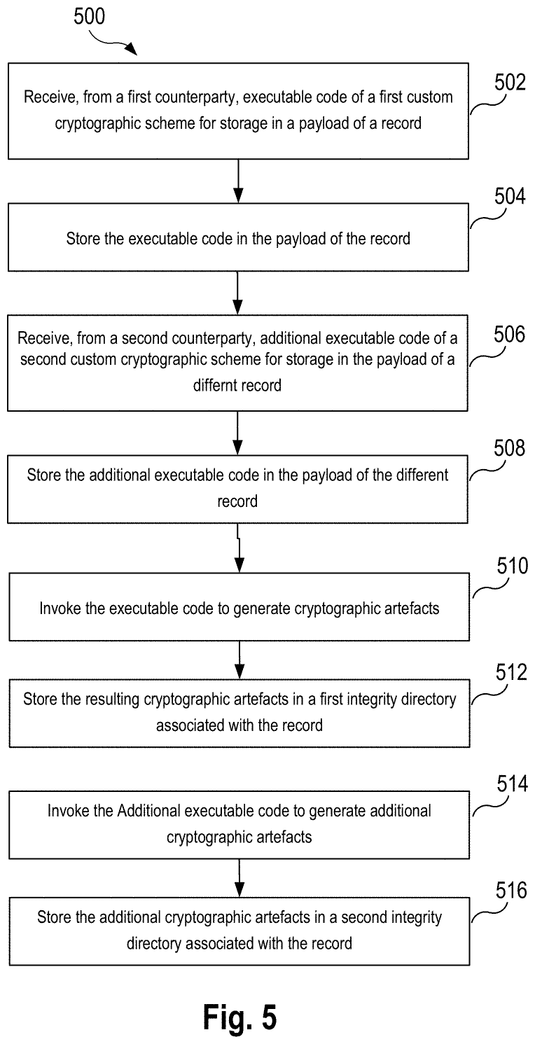

FIG. 5 is a flow diagram of method 500 for invoking custom cryptographic schemes, according to an exemplary aspect. Suppose that a new record that is to be added to a distributed ledger includes transactional information pertaining to two counterparties (e.g., companies). In particular, when the counterparties enter into an agreement, one or more objects (e.g., instances of custom smart contracts) are created within the platform. The platform maintains the integrity of the blockchain (used interchangeably with distributed ledger) comprising the states of those objects by using platform cryptography. The platform hashes may be kept within a platform-specific integrity directory. In terms of custom cryptography, each counterparty may provide a unique cryptographic scheme. The cryptographic schemes may be associated with their own respective integrity directories.

At 502, the platform receives, from a first counterparty, executable code of a first custom cryptographic scheme for storage in a payload of a record. For example, the first counterparty may decide to maintain additional cryptographic protection of their data by using a particular cryptography scheme (e.g., the first custom cryptography scheme).

At 504, the executable code is stored in the payload of the record. It should be noted that the record may be in a separate blockchain from where the transactional information is stored (much like any other executable code such as for a smart contract). Here, the cryptographic scheme can be thought of as a pluggable mechanism.

Subsequently, a second counterparty may or may not decide to use their own cryptographic scheme. In the event that the second counterparty wishes to use their own custom cryptographic scheme, at 506, the platform receives, from the second counterparty, additional executable code of a second custom cryptographic scheme for storage in the payload of a different record in a separate blockchain. At 508, the additional executable code is stored in the payload of the different record.

Upon entering the mutual agreement (e.g., a two-party trade), the first counterparty and the second counterparty indicate in the smart contract related to the agreement that they want to use their respective custom cryptographic schemes. It is done either through the code of the smart contract representing the agreement, or through the settings mechanism of the platform which allows using custom cryptographic schemes in any smart contract.

Whenever a platform receives a request to process the agreement, the platform cryptography scheme is used for blockchain building. However, whenever the first counterparty sends requests to the smart contract representing the agreement, the first custom cryptographic scheme is used, resulting in hashes and signatures stored in the first custom integrity directory of a generated record. When dealing with the objects in the context of the multi-party agreement considered here, at 510, the first counterparty applies the first custom cryptographic scheme by invoking the executable code. This results in a number of cryptographic artefacts (e.g., hashes) created in accordance with the first custom cryptographic scheme and related to the produced state of the object. At 512, the platform stores the resulting cryptographic artefacts in a first integrity directory associated with the record containing the produced state of the object.

Likewise, whenever the second counterparty sends requests to the smart contract representing the agreement, the second custom cryptographic scheme is used, resulting in hashes and signatures stored in the second custom integrity directory of the generated record. At 514, the second counterparty applies the second custom cryptographic scheme by invoking the additional executable code, which results in additional cryptographic artefacts.

At 516, the platform stores the resulting additional cryptographic artefacts in a second integrity directory associated with the record containing the produced state of the object. Given these two custom-generated cryptographic artefacts, the counterparties can use their knowledge of particular cryptography schemes for validating conformance of the states to those schemes, for example, by checking digital signatures. It should be noted that counterparties may agree (e.g., outside of the DLT) to maintain a common subset of cryptographic schemes for their transaction. With the help of the mechanisms described above, they can exchange cryptographic information directly through the DLT. Thus, these companies do not require additional offline support for multiple proprietary file formats that include digital signatures.

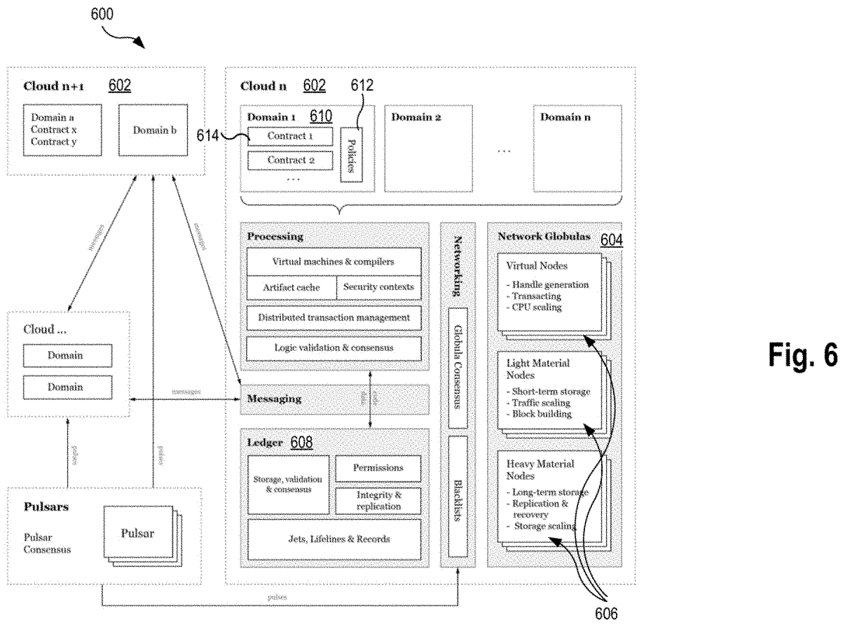

FIG. 6 is a block diagram illustrating an example architecture for a blockchain network of nodes. An example system 600 according to the depicted architecture shown in FIG. 4 can be configured to provide the blockchain network (110) of nodes suitable for managing the distributed ledger 114 and implementing extendable cryptography and associated techniques described herein.

The system 600 comprises a plurality of component and subcomponents that supports execution of a federation of clouds 602 (e.g., Cloud n, Cloud n+1), where each cloud 602 is run and governed independently (e.g., by a community, company, industry consortia, or national agency). In one aspect, each cloud 602 may be comprised of a blockchain network under a same node membership policy. Each cloud 602 organizes and unifies software capabilities, hardware capacities, and financial and legal liability of nodes to ensure transparent and seamless operation of business services. Each cloud 602 may include a globular network 604 having a plurality of nodes 606 (i.e., computing instances or servers that provide hardware capacity to a cloud). The globular network 604 may act as a backbone of a cloud, using a set of protocols enabling the coordination of networks of multitudes of nodes (e.g., 1,000's of nodes), including P2P networks and hierarchical nodes. In one aspect, the globular network 604 may be configured to run as a decentralized network with consistency between the nodes managed by a leaderless, byzantine fault tolerant (BFT)-based consensus mechanism. In some aspects, the system 600 may include larger node networks of multiple globular networks (e.g., 100 globulas each having 1,000 nodes for a total of 100,000 nodes) that behave transparently across such networks in accordance with whichever contract logic is in place, and that rely on an inter-globula network protocol with leader-based consensus.

In one aspect, each of the plurality of nodes 606 may be configured using a multi-role model: each node has a single static role (e.g., virtual, light material, heavy material, neutral) that defines its primary purpose and a set of dynamically assigned roles within the system 600. For example, a node having a virtual role performs calculations; a node having a light material role performs short-term data storage and network trafficking; a node having a heavy material role performs long-term data storage; and a node having a neutral role participates in the network consensus (not in the workload distribution) and has at least one utility role.

In one aspect, a cloud 602 may include one or more domains 610 which is a decentralized application that governs access to consensus, mutability, and other capabilities for other decentralized applications. The use of multiple domains (e.g., Domain 1, Domain 2, . . . Domain n) enables different governance models, and can be used to define policies 612 for data and (smart) contracts 614, such as policies that allow public or permissioned models, or to apply national or industry standards. In one aspect, domains 610 establish governance of contracts and nodes, thus acting as a super contract that can contain objects and their history and can apply varying policies to the objects contained therein.

In one aspect, the cloud 602 may be configured to store a distributed ledger 608 of data and records that are distributed across a network of nodes 606 that store data. In one aspect, data is stored in the ledger 608 as a series of immutable records. Records may be created and signed by virtual nodes. Each record may be addressed by its hash and a pulse number. Records can contain a reference to another record, thus, creating a chain. An example of a chain is the object's lifeline. Each material node may be responsible for its own lifelines determined by their hashes.

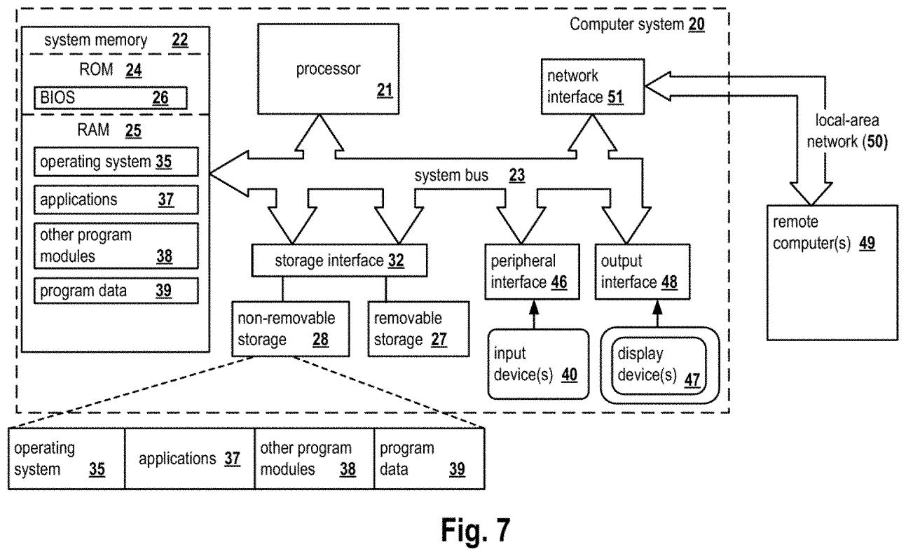

FIG. 7 is a block diagram illustrating a computer system 20 on which aspects of systems and methods for creating an extendable distributed ledger may be implemented in accordance with an exemplary aspect. It should be noted that the computer system 20 could correspond to the client device 102, for example, described earlier. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, Hyper Transport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, static random access memory (SRAM), dynamic random access memory (DRAM), zero capacitor RAM, twin transistor RAM, enhanced dynamic random access memory (eDRAM), extended data output random access memory (EDO RAM), double data rate random access memory (DDR RAM), electrically erasable programmable read-only memory (EEPROM), NRAM, resistive random access memory (RRAM), silicon-oxide-nitride-silicon (SONOS) based memory, phase-change random access memory (PRAM); flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 7, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for extendable cryptography in a distributed ledger comprising:
receiving a request to process an object by generating a new record data of the object and adding, to a distributed ledger, a new record comprising the new record data associated with the object;
obtaining hash information for a preceding record in the distributed ledger, the hash information comprising (1) a platform hash generated by a platform cryptographic scheme of the distributed ledger and (2) a custom hash generated by a custom cryptographic scheme for a security requirement;
generating, via the platform cryptographic scheme, a new platform hash for the new record;
generating, via the custom cryptographic scheme, a new custom hash for the new record;
creating a main portion of the new record, the main portion comprising (1) the new record data, (2) the platform hash of the previous record, and (3) the new platform hash;
generating and appending an extendable portion to the new record, wherein the extendable portion comprises (1) the custom hash of the previous record and (2) the new custom hash; and
adding the new record, comprising both the main portion and the extendable portion, to the distributed ledger.

2. The method of claim 1, wherein the main portion further comprises a record identifier of the new record.

3. The method of claim 1, wherein the new record data comprises information about a transaction between a first counterparty and a second counterparty, wherein the first counterparty provides the custom cryptographic scheme to the platform and the second counterparty provides a different custom cryptographic scheme to the platform, and wherein both the custom cryptographic scheme and the different custom cryptographic scheme are supported natively by the platform and not implemented on a business logic level, further comprising:
generating another custom hash via the different custom cryptographic scheme; and
including the another custom hash in the extendable portion.

4. The method of claim 3, wherein the custom cryptographic scheme comprises an algorithm for applying a cryptographic transformation and identifies compatible data formats for the cryptographic transformation, wherein being provided the custom cryptographic scheme comprises:
receiving executable code of the custom cryptographic scheme for storage in a payload of a record associated with an object dedicated for storing cryptographic schemes, prior to receiving the request to add the new record;
storing the executable code in the payload; and
invoking the executable code to generate the custom hash.

5. The method of claim 1, wherein custom hashes of all records in the distributed ledger are comprised in an integrity directory, wherein the integrity directory is a dedicated subsection of each record in the distributed ledger and comprises the extendable portion of the new record.

6. The method of claim 5, wherein each record may comprise a plurality of integrity directories, wherein each integrity directory is associated with one or more cryptography schemes.

7. The method of claim 5, wherein the integrity directory further comprises custom signatures.

8. The method of claim 5, wherein the integrity directory is a cross-record sequence for the distributed ledger.

9. The method of claim 5, wherein the integrity directory further comprises auxiliary information identifying physical nodes involved in transaction processing within the platform of the distributed ledger.

10. A system for extendable cryptography in a distributed ledger comprising:
a hardware processor configured to:
receive a request to process an object by generating a new record data of the object and adding, to a distributed ledger, a new record comprising the new record data associated with the object;
obtain hash information for a preceding record in the distributed ledger, the hash information comprising (1) a platform hash generated by a platform cryptographic scheme of the distributed ledger and (2) a custom hash generated by a custom cryptographic scheme for a security requirement;
generate, via the platform cryptographic scheme, a new platform hash for the new record;
generate, via the custom cryptographic scheme, a new custom hash for the new record;
create a main portion of the new record, the main portion comprising (1) the new record data, (2) the platform hash of the previous record, and (3) the new platform hash;
generate and append an extendable portion to the new record, wherein the extendable portion comprises (1) the custom hash of the previous record and (2) the new custom hash; and
add the new record, comprising both the main portion and the extendable portion, to the distributed ledger.

11. The method of claim 10, wherein the main portion further comprises a record identifier of the new record.

12. The system of claim 10, wherein the new record data comprises information about a transaction between a first counterparty and a second counterparty, wherein the first counterparty provides the custom cryptographic scheme to the platform and the second counterparty provides a different custom cryptographic scheme to the platform, and wherein both the custom cryptographic scheme and the different custom cryptographic scheme are supported natively by the platform and not implemented on a business logic level, wherein the hardware processor is further configured to:
generate another custom hash via the different custom cryptographic scheme; and
include the another custom hash in the extendable portion.

13. The system of claim 12, wherein the custom cryptographic scheme comprises an algorithm for applying a cryptographic transformation and identifies compatible data formats for the cryptographic transformation, wherein the hardware processor is further configured to:
receive executable code of the custom cryptographic scheme for storage in a payload of a record associated with an object dedicated for storing cryptographic schemes, prior to receiving the request to add the new record;
store the executable code in the payload; and
invoke the executable code to generate the custom hash.

14. The system of claim 10, wherein custom hashes of all records in the distributed ledger are comprised in an integrity directory, wherein the integrity directory is a dedicated subsection of each record in the distributed ledger and comprises the extendable portion of the new record.

15. The system of claim 14, wherein each record may comprise a plurality of integrity directories, wherein each integrity directory is associated with one or more cryptography schemes.

16. The system of claim 14, wherein the integrity directory further comprises custom signatures.

17. The system of claim 14, wherein the integrity directory is a cross-record sequence for the distributed ledger.

18. The system of claim 14, wherein the integrity directory further comprises auxiliary information identifying physical nodes involved in transaction processing within the platform of the distributed ledger.

19. A non-transitory computer readable medium storing thereon computer executable instructions for extendable cryptography in a distributed ledger, including instructions for:
receiving a request to process an object by generating a new record data of the object and adding, to a distributed ledger, a new record comprising the new record data associated with the object;
obtaining hash information for a preceding record in the distributed ledger, the hash information comprising (1) a platform hash generated by a platform cryptographic scheme of the distributed ledger and (2) a custom hash generated by a custom cryptographic scheme for a security requirement;
generating, via the platform cryptographic scheme, a new platform hash for the new record;
generating, via the custom cryptographic scheme, a new custom hash for the new record;
creating a main portion of the new record, the main portion comprising (1) the new record data, (2) the platform hash of the previous record, and (3) the new platform hash;
generating and appending an extendable portion to the new record, wherein the extendable portion comprises (1) the custom hash of the previous record and (2) the new custom hash; and
adding the new record, comprising both the main portion and the extendable portion, to the distributed ledger.

20. The non-transitory computer readable medium of claim 19, wherein the main portion further comprises a record identifier of the new record.
